(19) United States
(12) Patent Application Publication
(10) Pub. No.: US 2022/0309560 A1
(43) Pub. Date: Sep. 29, 2022

(54) SYSTEM AND METHOD FOR PROVIDING AN INFORMATION RELATED TO SIMILAR PRODUCT OF A PRODUCT

(71) Applicant: FLIPKART INTERNET PRIVATE LIMITED, Bengaluru (IN)

(72) Inventors: Praneet Ashok Mehta, Ratlam (IN); Krishna Azad Tripathi, Jaipur (IN); Jayesh Bageriya, Indore (IN)

(73) Assignee: FLIPKART INTERNET PRIVATE LIMITED, Bengaluru (IN)

(21) Appl. No.: 17/696,703

(22) Filed: Mar. 16, 2022

(30) Foreign Application Priority Data
Mar. 26, 2021 (IN) 202141013442

(51) Int. Cl. G06Q 30/06; G06Q 10/08

(52) U.S. Cl. CPC G06Q 30/0631; G06Q 10/087; G06Q 30/0627

(57) ABSTRACT

A system and method for providing an information related to similar product of a product. The method encompasses receiving at least one numeric query comprising numeric part/s and non-numeric part/s. The method thereafter comprises identifying an availability of product/s corresponding to the at least one numeric query. Further, the method encompasses generating a positive indication and/or a negative indication based on the identification of the availability of the product/s. The method thereafter encompasses identifying at least one numeric alternate for the numeric part/s based on the negative indication, an intent of the at least one non-numeric part of said each numeric query and an availability of similar product/s of the product/s. Further the method comprises providing an information related to the similar product/s based on the at least one numeric alternate of the numeric part/s and the availability of the similar product/s.

### TECHNICAL FIELD

The field generally relates to digital platforms and more particularly to systems and methods for providing an information related to one or more similar products of at least one product on a digital platform.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With the advancement in digital technologies, over the past few years digital platforms such as including but not limited to e-commerce platforms, social media platforms, mobile commerce platforms, websites and the like are enhanced to a great extent. These digital platforms provide users a number of services and facilities such as real time communication, real time access to various information, online shopping and the like facilities. Furthermore, a user to avail the digital services such as to buy a product via the e-commerce platforms inputs a query related to such product. Further, based on such user query, one or more relevant products are displayed to the user with an information of such one or more relevant products. Further the information comprises an information related to availability of such products, information related to specifications of such products, information related to various offers on such products and/or the like.

Further, to provide the users digital services and facilities efficiently and effectively, it is important to provide the users with an information related to the most relevant product that user is looking for. Therefore, to provide the users an information of one or more relevant products on a digital platform, a number of solutions are developed time to time. However, given a user-query with numeric values such as price, internal storage, RAM, capacity etc., many times there are no relevant set of products available over a digital platform, therefore, the known solutions end up showing irrelevant products, which confuses the user. For example, the currently known solutions are not able to resolve for the correct price range if a digital platform does not carry the products based on a user query comprising the price range, and therefore the currently known solutions end up showing very high or very low-priced products to the user. Furthermore, currently there is no framework to efficiently provide the users an information of one or more alternate/similar products of the one or more products the users are looking for, in an event said one or more products are not available. More particularly, in events where a user query (such as a 64 GB ABC RAM) comprises a numeric part (64 GB) and a non-numeric part (ABC RAM) and no product based on such user query is available, the currently known solutions fail to provide an information related to an alternate/a similar product for such unavailable product based at least on the numeric part of the user query. The currently known solutions are majorly focused on the non-numeric part of a user query to provide information related to alternate products in events where product/s based on the user query are not available. Also, in such events the currently known solutions fail to consider the numeric part of the user query to provide information related to the alternate products available. Therefore, most of the times irrelevant recommendation of available alternate products are provided to the users based on the currently known solutions.

Furthermore, in events where a product corresponding to a user query is not available over a digital platform, the currently known solutions always operate based on a pre-defined database of said digital platform, which means, the known solutions try to map closest to the user query, a database which is only available on the digital platform. Therefore, due to the reliance on the limited and/or fixed data no relevant alternate/similar products are displayed to the user and the user might end up seeing the wider range of products. More particularly, the known solutions fail to operate on external data and the existing catalog/database of a single digital platform does not have enough information such as numeric values/ranges of a user query and therefore the known solutions are not able to suggest to the users the closest possible product set.

Therefore, there is need in the art to provide a solution to efficiently and effectively provide an information related to one or more similar products of at least one product based on a user query and an unavailability of such at least one product on a digital platform.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for providing an information related to one or more similar products of at least one product. Another object of the present invention is to identify a user intent of a user query (e.g., numeric user query) along with its numeric part. Also an object of the present invention is to identify an availability of product/s satisfying a specific criteria of a user query (such as an intent of a non-numeric part of the user query) along with numeric parts of the user query into a product index. Another object of the present invention is to identify a selection gap (e.g., an unavailability of one or more products corresponding to a user query). Also, an object of the present invention is to identify a user/numeric query as a candidate for selection gap transformation (e.g., numeric part transformation) in an event if a resultant product count satisfying a specific criteria of the user query is very low (or zero). Also, for a numeric user-query for which no relevant products are available, an object of the present invention is to transform the numeric part of the user-query into another nearby form for which a relevant selection of one or more products is available (e.g., selection gap transformation). An object of the present invention is to get nearest possible relevant product/s of one or more unavailable products based on getting a nearest possible numeric value for transformation of the numeric part of the user-query. Also an object of the present invention is to build a knowledge graph to get a numeric value similarity for numeric part transformation, based on various pivots (such as for price attribute, getting a ratio similarity which is based on a ratio of available vs asked price range). Yet another object of the present invention is to change a user query to have a nearest numeric range, based on an available nearest numeric range of an input query corresponding to one or more unavailable products, such that the transformation/change helps to present the closest available products to the one that user has asked (e.g., the one or more unavailable products).

Furthermore, in order to achieve the aforementioned objectives, the present invention provides a method and system for providing an information related to one or more similar products of at least one product on a digital platform. In an implementation the digital platform is an e-commerce platform.

A first aspect of the present invention relates to the method for providing an information related to one or more similar products of at least one product. The method encompasses receiving, at a transceiver unit, at least one numeric query, wherein each numeric query comprises at least one numeric part and at least one non-numeric part. The method thereafter comprises identifying, by a processing unit, an availability of at least one product corresponding to the at least one numeric query. Further the method leads to generating, by the processing unit, one of a positive indication and a negative indication based on the identification of the availability of the at least one product. The method thereafter encompasses identifying, by the processing unit, at least one numeric alternate for the at least one numeric part of the each numeric query based on the negative indication, an intent of the at least one non-numeric part of said each numeric query and an availability of one or more similar products of the at least one product. Further the method comprises providing, by the processing unit at a display unit, an information related to the one or more similar products based on the at least one numeric alternate of the at least one numeric part and the availability of the one or more similar products.

Another aspect of the present invention relates to a system for providing an information related to one or more similar products of at least one product. The system comprises a transceiver unit, configured to receive, at least one numeric query, wherein each numeric query comprises at least one numeric part and at least one non-numeric part. The system further comprises a processing unit configured to identify, an availability of at least one product corresponding to the at least one numeric query. The processing unit is thereafter configured to generate, one of a positive indication and a negative indication based on the identification of the availability of the at least one product. Further the processing unit is configured to identify, at least one numeric alternate for the at least one numeric part of the each numeric query based on the negative indication, an intent of the at least one non-numeric part of said each numeric query and an availability of one or more similar products of the at least one product. Thereafter the processing unit is configured to provide, at a display unit, an information related to the one or more similar products based on the at least one numeric alternate of the at least one numeric part and the availability of the one or more similar products.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for providing an information related to one or more similar products of at least one product, in accordance with exemplary embodiments of the present invention.

FIG. 2 illustrates an exemplary method flow diagram [200], depicting a method for providing an information related to one or more similar products of at least one product, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, a storage unit, a display unit, a transceiver unit and any other such unit(s) which are obvious to the person skilled in the art and are capable of implementing the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein the “Transceiver Unit” may include but not limited to a transmitter to transmit data to one or more destinations and a receiver to receive data from one or more sources. Further, the Transceiver Unit may include any other similar unit obvious to a person skilled in the art, to implement the features of the present invention. The transceiver unit may convert data or information to signals and vice versa for the purpose of transmitting and receiving respectively.

As disclosed in the background section the existing technologies have many limitations and in order to overcome at least some of the limitations of the prior known solutions, the present disclosure provides a solution for providing an information related to one or more similar products of at least one product on a digital platform. More particularly, the present invention encompasses providing the information related to the one or more similar products of the at least one product in an event the at least one product corresponding a user query is not available on the digital platform, wherein the user query encompasses a numeric part and a non-numeric part. Furthermore, to identify an availability of the at least one product corresponding the user query, the present invention encompasses identifying a user intent based on the non-numeric part of the user query and the numeric part of the user query. Once the user intent and the numeric part of the user query is identified, the present invention identifies if the at least one product corresponding to the user query is available or not. Thereafter, in an event no product/s corresponding to the user query is available, the present invention encompasses providing the information related to the one or more similar products of the at least one unavailable product.

Further, the one or more similar products encompasses one or more closest product to the at least one product. Furthermore, the present invention encompasses determining the one or more closest products to the at least one product based at least on the intent and the numeric part of the user query. Also, the intent of the user query is determined based on a pre-trained dataset. Thereafter, in order to provide the information related to the one or more similar products the present invention encompasses a transformation of the numeric part of the user query. Furthermore, the transformation of the numeric part is based on a nearest possible numeric value of said numeric part, wherein the nearest possible numeric value is determined based at least on a knowledge graph. The knowledge graph is a graphical representation of a plurality of data related to a plurality of products available on the digital platform and one or more publicly available digital data platforms. More particularly, said graphical representation indicates a relation between one or more numeric attributes associated with each product from the plurality of products. Therefore, in the knowledge graph one or more products based on the one or more numeric attributes are connected and have similarity scores which further used to determine the similarity between the numeric part of the user query and the nearest possible numeric value of said numeric part. In an implementation the determination of nearest possible numeric value is further based on the intent of the user query. The present invention thereafter based on the availability of the one or more similar products and the transformation of the numeric part of the user query, provides the information related to the one or more similar products of the at least one product (i.e. the at least one unavailable product) on the digital platform.

Hereinafter, exemplary embodiments of the present disclosure will be described in detail with reference to the accompanying drawings so that those skilled in the art can easily carry out the present disclosure.

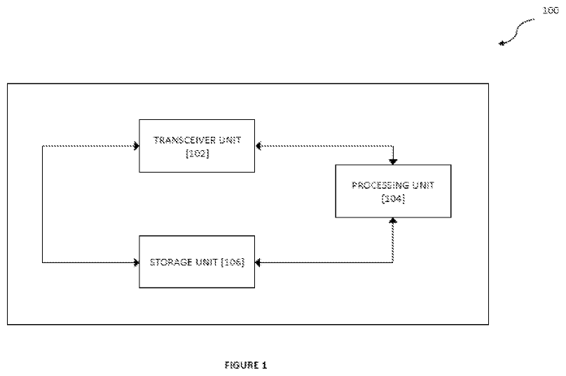

Referring to FIG. 1, an exemplary block diagram of a system [100] for providing an information related to one or more similar products of at least one product, in accordance with exemplary embodiments of the present invention is shown. The digital platform can be accessed via an electronic/user device.

The system [100] comprises at least one transceiver unit [102], at least one processing unit [104] and at least one storage unit [106]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] is connected to a user device of a user to implement the features of the present invention. Also, in yet another implementation the system [100] as a whole or partly, may be present in a server device to implement the features of the present invention.

The system [100] is configured to provide, an information related to one or more similar products of at least one product on a digital platform, wherein the digital platform is accessed on the user device, with the help of the interconnection between the components/units of the system [100].

The transceiver unit [102] is configured to receive, at least one numeric query, wherein each numeric query comprises at least one numeric part and at least one non-numeric part. The at least one numeric part is at least one of at least one fixed numeric value and at least one numeric value range. Furthermore, the numeric value range may be any possible values/numbers/digits between two numeric values. More particularly, a numeric query with a numeric value range is received where a user is looking to search a product in a range. For example, a user query ‘phone under 500’ comprises a numeric value range i.e. phones in the price range (0, 500). Also, in one other example a user/numeric query i.e. Phones from 5000 to 7000 Rs is also a numeric query with a numeric value range of 5000 to 7000. In yet another example, a user query i.e. phones over 10,000 Rs is also a numeric query with a numeric value range of 10,000 to Maximum price. Further, the fixed numeric value is only a specific numeric value. For example ‘Phone with RAM 16 GB’ is a numeric query with fixed numeric value i.e. 16. More particularly, each numeric query is a query having numeric components such as price, RAM (random access memory), storage, size, resolution, etc. Further these numeric components may be the fixed numeric value and/or the numeric value range such as price range between Rs. 200 to Rs. 500, a 32 GB RAM and the like. Further, the non-numeric part is a non-numeric information present in the each user query/numeric query, such as one or more words indicating a type of a product, a brand of a product, a color of a product and the like.

Once the at least one numeric query is received at the transceiver unit [102], the processing unit [104] connected to the transceiver unit [102] is configured to identify on the digital platform, an availability of at least one product corresponding to the at least one numeric query. Furthermore, to identify the availability of at least one product, the processing unit [104] is configured to identify the numeric part of the each received numeric query and an intent of the each received numeric query. The intent of the each received numeric query comprises one or more parameters related to the at least one product, wherein the one or more parameters are based on attribute value/s of the non-numeric part of the each numeric query. Also, the intent of the received numeric query is identified based on a pre-trained dataset, wherein the pre-trained dataset comprises a plurality of data associated with a plurality of products available worldwide. Furthermore, the plurality of data associated with the plurality of products may include but not limited to a plurality of numeric values and attributes associated with the plurality of products. Furthermore, the processing unit [104] is configured to identify the intent of the each numeric query based on the non-numeric part of the each numeric query and the pre-trained dataset. More particularly, to identify the intent of the each numeric query, the processing unit [104] is configured to determine the intent of the at least one non-numeric part of the each numeric query based at least on one or more non-numeric information present in the each numeric query and the pre-trained dataset. Also, the processing unit [104] is configured to identify the numeric part of the each numeric query based on a knowledge graph comprising at least a plurality of numeric values and attributes associated with the plurality of products. More specifically, the knowledge graph is a graphical representation of a plurality of data related to the plurality of products available on the digital platform and the one or more publicly available digital data platforms. For example, if a numeric query ‘ABC laptop under 50,000 INR’ is received, then the processing unit [104] is configured to identify the intent of the numeric query i.e. ‘ABC brand and product laptop’ based on the non-numeric part i.e. ABC laptop and the pre-trained dataset. Thereafter the processing unit [104] is configured to identify, the numeric part i.e. price range (0, 50,000) INR based on the knowledge graph. Further, the processing unit [104] is configured to identify an availability of the ABC laptop on a digital platform based on the identification of the ABC brand's laptop (i.e. the intent) and the identification of the price range (0, 50,000) (i.e. the numeric part) in the received numeric query. Also, in an implementation, the digital platform is an e-commerce platform.

Thereafter the processing unit [104] is configured to generate, one of a positive indication and a negative indication based on the identification of the availability of the at least one product. The positive indication is generated based on a successful identification of the availability of the at least one product on the digital platform. The negative indication is generated based on an unsuccessful identification of the availability of the at least one product on the digital platform. Further, considering the above stated example, if the ABC laptop with a price lesser than 50000 INR is successfully identified to be available on the digital platform the positive indication is generated. Also, in the given example if the ABC laptop with the price lesser than 50000 INR is identified to be not available on the digital platform the negative indication is generated.

Further the processing unit [104] is configured to identify, at least one numeric alternate for the at least one numeric part of the each numeric query based on the negative indication, the intent of the at least one non-numeric part of said each numeric query and an availability of one or more similar products of the at least one product. The at least one numeric alternate of the at least one numeric part is at least one alternative of the at least one numeric part of the each numeric query. More particularly, the at least one numeric alternate of the at least one numeric part is a nearest possible numeric value of at least one of the at least one fixed numeric value and the at least one numeric value range. For example, if a numeric part of a numeric query i.e. ‘ABC laptop with 64 bit windows operating system’ is identified to be 64 bit, then the numeric alternate for 64 bit is identified based on the negative indication (i.e. the unavailability of the ABC laptop having 64 bit windows operating system on the digital platform), the intent of non-numeric part of said numeric query (i.e. the features ABC brand, product laptop and operating system windows) and an availability of one or more products similar to the ABC laptop having windows operating system on the digital platform.

Further, in an implementation the processing unit [104] is also configured to further identify the at least one numeric alternate for the at least one numeric part based on the knowledge graph i.e. the graphical representation of the plurality of data related to the plurality of products available on the digital platform and one or more publicly available digital data platforms. Furthermore, said graphical representation indicates a relation between one or more numeric attributes associated with each product from the plurality of products. Therefore, in the knowledge graph one or more products based on the one or more numeric attributes are connected and have similarity scores which further used to determine the similarity between the numeric part of the user query and the nearest possible numeric value of said numeric part. In an implementation the determination of nearest possible numeric value is further based on the intent of the user query, wherein the intent of the user query is determined based on the pre-trained dataset. The pre-trained dataset comprises the plurality of data associated with the plurality of products available worldwide. More particularly, the pre-trained dataset is a dataset trained on the basis of a plurality of data related to a plurality of products available on the digital platform and the one or more publicly available digital data platforms. Also, the processing unit [104] is further configured to update the pre-trained dataset based on a change in the available data on the said digital platform and the one or more publicly available digital data platforms. Furthermore, the pre-trained dataset may be periodically or dynamically updated.

Furthermore, in an implementation to identify the at least one numeric alternate for the at least one numeric part, the processing unit [104] is configured to identify the nearest possible numeric value of the numeric part (i.e. at least one of the at least one fixed numeric value and the at least one numeric value range of the numeric query) based on identified numeric part and the knowledge graph. For example, if a numeric query is ‘12 GB XYZ phone’, then the numeric part of said numeric query is identified to be 12 GB and the processing unit [104] is configured to identify the at least one numeric alternate for the numeric part i.e. 12 GB based on the negative indication (i.e. unavailability of 12 GB XYZ phone on the digital platform), intent of the non-numeric part of said numeric query (i.e. brand XYZ, product phone and storage GB), an availability of one or more products similar to the XYZ phone having storage space in GBs on the digital platform and a plurality of data related to 12 GB XYZ phone present in the knowledge graph. In an exemplary instance for the given example, the numeric alternate for the numeric part i.e. 12 GB may be identified as 8 GB if the knowledge graph comprises the nearest possible numeric value 8 GB associated with the intent (i.e. brand XYZ, product phone and storage GB) and the one or more available products similar to the XYZ phone having the storage space in GBs. Also, in another instance the numeric alternate for the numeric part 12 GB may be identified as 16 GB, if the knowledge graph comprises the nearest possible numeric value 16 GB associated with the intent (i.e. brand XYZ, product phone and storage GB) and the one or more available products similar to the XYZ phone having the storage space in GBs.

Furthermore, the availability of the one or more similar products is also identified based at least on the intent of the at least one non-numeric part of the each numeric query. More specifically, the processing unit [104] is configured to identify the one or more similar products of the at least one product based on the intent of the at least one non-numeric part of the each numeric query from the at least one numeric query. For example, a numeric query ‘ XYZ shirt 40 Size Blue Color’, is received and no corresponding Blue Shirt of XYZ brand with size 40 is available on a digital platform, then in such scenario the processing unit is configured to identify an availability of one or more similar product based on the intent of the at least one non-numeric part i.e. XYZ Shirt, Blue Color. Therefore, one or more available products having the intent i.e. XYZ Shirt, Blue Color are identified by the processing unit [104].

The processing unit [104] is thereafter configured to provide, at a display unit of the user device, an information related to the one or more similar products based on the at least one numeric alternate of the at least one numeric part and the availability of the one or more similar products. Also, in an implementation if more than one numeric part is present in each numeric query, the processing unit [104] is configured to identify an numeric alternate for each of the numeric parts and to display the information related to the one or more similar products, the numeric alternate for the most closest numeric part is considered. Furthermore, the information related to the one or more similar products comprises a detail of the one or more available similar products having attribute/s of the at least one numeric alternate of the at least one numeric part. Further, the processing unit [104] in order to provide at the display unit, the information related to the one or more similar products is configured to automatically replace the at least one numeric part with the at least one numeric alternate of said at least one numeric part based at least on the negative indication and the availability of the one or more similar products. For example, for a query “lamp under 200”, numeric part is a price range (0, 200). If one or more lamps are not available in this price range, based on the knowledge graph, the processing unit [104] is configured to identify an alternate for the numeric part, i.e. a new range (0, y) is identified for price range (0, 200) by the processing unit [104], to replace the numeric part 200 with the numeric alternate value ‘y’ of said numeric part 200. Similarly in an implementation for numeric queries with ranges having both lower and upper bound, the numeric alternate for both the lower and upper bound are identified by the processing unit [104]. Also, for numeric queries with ranges having only lower bound (such as (10000, Maximum)), the numeric alternate for the lower bound is identified by the processing unit [104]. Further, considering the above stated example where the numeric query is ‘XYZ shirt 40 Size Blue Color’ and no such product is available on the digital platform, the processing unit [104] is configured to replace the numeric part 40 (i.e. the fixed numeric value) to at least one numeric alternate of 40, based on the unavailability of the XYZ brand's blue shirt of 40 size and an availability of one or more available similar shirts i.e. shirt/s with intent XYZ brand, blue color and product shirt. In an exemplary instance, in the given example numeric alternate of size 40 may be identified as at least one of a size 39 and size 40, based on the identified nearest possible numeric value. Therefore, the processing unit [104] is configured to automatically replace 40 with at least one of 39 and 41.

Further, considering the above example, for numeric query ‘XYZ shirt 40 Size Blue Color’, with no availability of corresponding Blue Shirt of XYZ brand with size 40 on a digital platform, the processing unit [104] is configured to identify the intent i.e. XYZ Shirt, Blue Color, to identify an availability of the one or more similar product based on the intent. Once, the one or more available similar products having the intent are identified by the processing unit [104], the processing unit [104] is thereafter configured to identify at least one numeric alternate of the numeric part of said query i.e. 40 in the given example. In an exemplary instance the at least one numeric alternate may be identified as at least one of a size 39 and a size 41, based at least on the identified nearest possible numeric value. Thereafter, the processing unit [104] based on the identified one or more available similar products (i.e. blue color shirt of XYZ brand) and at least one of the size 39 and the size 41, is configured to display an information related to the one or more similar products. Furthermore, as the information related to the one or more similar products comprises the detail of the one or more available similar products having attributes of the at least one numeric alternate of the at least one numeric part, in the given example the blue color shirt of XYZ brand with at least one of the size 39 and 41 are displayed at the display unit of the user device.

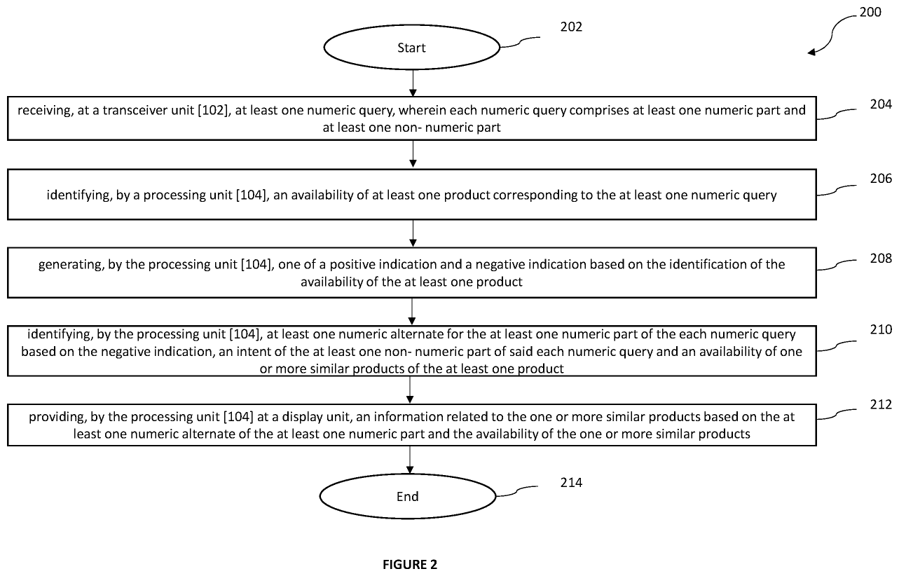

Referring to FIG. 2, an exemplary method flow diagram [200], depicting a method for providing an information related to one or more similar products of at least one product, in accordance with exemplary embodiments of the present invention is shown. In an implementation the method is performed on an electronic/user device by system [100] and the digital platform is accessed by the target user on the electronic device. Also, as shown in FIG. 2, the method starts at step [202].

Thereafter at step [204] the method comprises receiving, at a transceiver unit [102], at least one numeric query, wherein each numeric query comprises at least one numeric part and at least one non-numeric part. The at least one numeric part is at least one of at least one fixed numeric value and at least one numeric value range. Furthermore, the numeric value range may be any possible numerical values between two numeric values. More particularly, the method encompasses receiving a numeric query with a numeric value range, in instances where a user is looking to search a product in a range. For example, a user query ‘pen under 200’ comprises a numeric value range i.e. pens in the price range (0, 200). Also, in one other example a user/numeric query i.e. watches from 6000 to 8000 Rs is also a numeric query with a numeric value range of 6000 to 8000. In yet another example, a user query i.e. watches over 11,000 Rs is also a numeric query with a numeric value range of 11,000 to Maximum price available. Further, the fixed numeric value is only a specific numeric value. For example ‘Phone with RAM 8 GB’ is a numeric query with fixed numeric value i.e. 8. More particularly, each numeric query is a query having numeric components such as price, RAM, ROM (read only memory), storage, size, resolution, etc. Further these numeric components may be the fixed numeric value and/or the numeric value range such as price range between Rs. 2000 to Rs. 3000, a 64 GB RAM and the like. Further, the non-numeric part is a non-numeric information present in the each user query/numeric query, such as one or more words indicating a type of a product, a brand of a product, a color of a product and the like.

Further at step [206] the method comprises identifying, by a processing unit [104], an availability of at least one product corresponding to the at least one numeric query, on the digital platform. Furthermore, to identify the availability of at least one product, the method encompasses identifying by the processing unit [104], the numeric part of the each received numeric query and an intent of the each received numeric query. The intent of the each received numeric query comprises one or more parameters related to the at least one product, wherein the one or more parameters are based on attribute value/s of the non-numeric part of the each numeric query. Also, the intent of the received numeric query is identified based on a pre-trained dataset, wherein the pre-trained dataset comprises a plurality of data associated with a plurality of products available worldwide. Furthermore, the plurality of data associated with the plurality of products may include but not limited to a plurality of numeric values and attributes associated with the plurality of products. Furthermore, the method encompasses identifying by the processing unit [104], the intent of the each numeric query based on the non-numeric part of the each numeric query and the pre-trained dataset. More particularly, to identify the intent of the each numeric query, the method encompasses determining by the processing unit [104], the intent of the at least one non-numeric part of the each numeric query based at least on one or more non-numeric information present in the each numeric query and the pre-trained dataset. Also, the method encompasses identifying by the processing unit [104], the numeric part of the each numeric query based on a knowledge graph comprising at least a plurality of numeric values and the attributes associated with the plurality of products. More specifically, the knowledge graph is a graphical representation of a plurality of data related to the plurality of products available on the digital platform and the one or more publicly available digital data platforms. For example, if a numeric query ‘ABC bags under 5000 INR’ is received, then the method comprises identifying by the processing unit [104], the intent of the numeric query i.e. ‘ABC brand and product bags based on the non-numeric part i.e. ABC bags and the pre-trained dataset. Thereafter the method encompasses identifying by the processing unit [104], the numeric part i.e. price range (0, 5000) INR based on the knowledge graph. Further, the method encompasses identifying by the processing unit [104], an availability of the ABC bags on a digital platform based on the identification of the ABC brand's bags (i.e. the intent) and the identification of the price range (0, 5000) (i.e. the numeric part) in the received numeric query. Also, in an implementation, the digital platform is an e-commerce platform.

Next, at step [208], the method comprises generating, by the processing unit [104], one of a positive indication and a negative indication based on the identification of the availability of the at least one product. The positive indication is generated based on a successful identification of the availability of the at least one product on the digital platform. The negative indication is generated based on an unsuccessful identification of the availability of the at least one product on the digital platform. Further, considering the above stated example, if the ABC bags with a price lesser than 5000 INR is successfully identified to be available on the digital platform the positive indication is generated. Also, in the given example if the ABC bags with the price lesser than 5000 INR is identified to be not available on the digital platform the negative indication is generated.

Further the method at step [210] comprises identifying, by the processing unit [104], at least one numeric alternate for the at least one numeric part of the each numeric query based on the negative indication, an intent of the at least one non-numeric part of said each numeric query and an availability of one or more similar products of the at least one product. The at least one numeric alternate of the at least one numeric part is a nearest possible numeric value of at least one of the at least one fixed numeric value and the at least one numeric value range. For example, if a numeric part of a numeric query i.e. ‘XYZ laptop with 32 bit windows operating system’ is identified to be 32 bit, then the numeric alternate for 32 bit is identified based on the negative indication (i.e. the unavailability of the XYZ laptop having 32 bit windows operating system on the digital platform), the intent of non-numeric part of said numeric query (i.e. the features XYZ brand, product laptop and operating system windows) and an availability of one or more products similar to the XYZ laptop having windows operating system, on the digital platform.

Also, in an implementation the process of identifying, by the processing unit [104], at least one numeric alternate for the at least one numeric part is further based on the knowledge graph i.e. the graphical representation of the plurality of data related to the plurality of products available on the digital platform and one or more publicly available digital data platforms. Furthermore, said graphical representation indicates a relation between one or more numeric attributes associated with each product from the plurality of products. Therefore, in the knowledge graph one or more products based on the one or more numeric attributes are connected and have similarity scores which further used to determine the similarity between the numeric part of the user query and the nearest possible numeric value of said numeric part. In an implementation the determination of nearest possible numeric value is further based on the intent of the user query, wherein the intent of the user query is determined based on the pre-trained dataset. The pre-trained dataset comprises the plurality of data associated with the plurality of products available worldwide. More particularly, the pre-trained dataset is a dataset trained on the basis of a plurality of data related to a plurality of products available on the digital platform and the one or more publicly available digital data platforms. Also, the method further comprises updating by the processing unit [104], the pre-trained dataset based on a change in the available data on the said digital platform and the one or more publicly available digital data platforms. Furthermore, the pre-trained dataset may be periodically or a dynamically updated.

Furthermore, in an implementation to identify the at least one numeric alternate for the at least one numeric part, the method also encompasses identifying by the processing unit [104], the nearest possible numeric value of the numeric part (i.e. at least one of the at least one fixed numeric value and the at least one numeric value range of the numeric query) based on identified numeric part and the knowledge graph. For example, if a numeric query is ‘3 GB XYZ RAM’, then the numeric part of said numeric query is identified to be 3 GB and the method comprises identifying by the processing unit [104], the at least one numeric alternate for the numeric part i.e. 3 GB based on the negative indication (i.e. unavailability of 3 GB XYZ RAM on the digital platform), intent of the non-numeric part of said numeric query (i.e. brand XYZ, product RAM and storage in GB), an availability of one or more products similar to the XYZ RAM having storage space in GBs on the digital platform and a plurality of data related to 3 GB XYZ RAM present in the knowledge graph. In an exemplary instance for the given example, the numeric alternate for the numeric part i.e. 3 GB may be identified as 2 GB if the knowledge graph comprises the nearest possible numeric value 2 GB associated with the intent (i.e. brand XYZ, product RAM and storage in GB) and the one or more available products similar to the XYZ RAM having the storage space in GBs. Also, in another instance the numeric alternate for the numeric part 3 GB may be identified as 4 GB, if the knowledge graph comprises the nearest possible numeric value 4 GB associated with the intent (i.e. brand XYZ, product RAM and storage capacity in GB) and the one or more available products similar to the XYZ RAM having the storage space in GBs.

Further, the availability of the one or more similar products is also identified based at least on the intent of the at least one non-numeric part of the each numeric query. More specifically, the method encompasses identifying by the processing unit [104], the one or more similar products of the at least one product based on the intent of the at least one non-numeric part of the each numeric query from the at least one numeric query. For example, a numeric query ‘ABC T-shirt of 42 Size Red Color’, is received and no corresponding Red T-Shirt of ABC brand with size 42 is available on a digital platform, then in such scenario the method comprises identifying by the processing unit [104], an availability of one or more similar product based on the intent of the at least one non-numeric part i.e. Color Red, ABC, T-Shirt. Therefore, one or more available products having the intent i.e. Color Red, Brand XYZ, product T-Shirt, are identified by the processing unit [104].

Thereafter, the method at step [212] comprises providing, by the processing unit [104] at a display unit, an information related to the one or more similar products based on the at least one numeric alternate of the at least one numeric part and the availability of the one or more similar products. Also, in an implementation if more than one numeric part is present in each numeric query, the method encompasses identifying by the processing unit [104], an numeric alternate for each of the numeric parts and, thereafter, to display the information related to the one or more similar products, the numeric alternate for the most closest numeric part is considered. Furthermore, the information related to the one or more similar products comprises a detail of the one or more available similar products having attribute/s of the at least one numeric alternate of the at least one numeric part.

Further, the process of providing, by the processing unit [104] at a display unit, an information related to the one or more similar products further comprises automatically replacing, by the processing unit [104], the at least one numeric part with the at least one numeric alternate of said at least one numeric part based at least on the negative indication and the availability of the one or more similar products. For example, for a query “Type C Charger under 200”, numeric part is a price range (0, 200). If one or more Type C Chargers are not available in this price range, based on the pre-trained dataset, the method encompasses identifying by processing unit [104], an alternate for the numeric part, i.e. a new range (0, y) is identified for price range (0, 200) to replace the price range (0, 200) with the new range (0, y). Similarly in an implementation for numeric queries with ranges having both lower and upper bound, the numeric alternate for both the lower and upper bound are identified by the processing unit [104]. Also, for numeric queries with ranges having only lower bound (such as (10000, Maximum)), the numeric alternate for the lower bound is identified by the processing unit [104]. Further, considering an example where the numeric query is ‘XYZ shirt 42 Size Blue Color’ and no such product is available on the digital platform, the method encompasses replacing by the processing unit [104], the numeric part 42 (i.e. the fixed numeric value) to at least one numeric alternate of 42, based on the unavailability of the XYZ brand's blue shirt of 42 size and an availability of one or more similar shirts i.e. shirt/s with intent XYZ brand, blue color and product shirt. In an exemplary instance, in the given example numeric alternate of size 42 may be identified as at least one of a size 41 and size 43, based at least on the identified nearest possible numeric value. Therefore, the method comprises automatically replacing by the processing unit [104], 42 with at least one of 41 and 43.

Further, considering the above example, for numeric query ‘XYZ shirt 42 Size Blue Color’, with no availability of corresponding Blue Shirt of XYZ brand with size 42 on a digital platform, the method also comprises identifying by the processing unit [104], the intent i.e. XYZ, Shirt, Blue Color, to identify an availability of the one or more similar product based on the intent. Once, the one or more available similar products having the intent are identified, the method thereafter encompasses identifying by the processing unit [104] at least one numeric alternate of the numeric part of said query i.e. 42 in the given example. In an exemplary instance the at least one numeric alternate may be identified as at least one of a size 41 and a size 43, based at least on the identification of at least one of the 41 and 43 as nearest possible numeric value. Thereafter, the method based on the identified one or more available similar products (i.e. blue color shirt of XYZ brand) and at least one of the size 41 and the size 43, comprises displaying by the processing unit [104], an information related to the one or more similar products. Furthermore, as the information related to the one or more similar products comprises the detail of the one or more available similar products having attributes of the at least one numeric alternate of the at least one numeric part, in the given example the blue color shirt of XYZ brand with at least one of the size 41 and 43 are displayed at the display unit of the user device.

The method thereafter terminates at step [214].

Thus, the present invention provides a novel solution for providing an information related to an available product similar to an unavailable product searched by a user.

More particularly, the present invention provides a solution to provide an alternative product of an unavailable product based on a nearest possible numeric value of one or more numeric values present in a user query received for the unavailable product. Furthermore, the present invention provides a solution to provide an information related to an available product similar to an unavailable product based on a huge dataset which is not limited to a single digital platform.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method for providing an information related to one or more similar products of at least one product, the method comprising:
receiving, at a transceiver unit [102], at least one numeric query, wherein each numeric query comprises at least one numeric part and at least one non-numeric part;
identifying, by a processing unit [104], an availability of at least one product corresponding to the at least one numeric query;
generating, by the processing unit [104], one of a positive indication and a negative indication based on the identification of the availability of the at least one product;
identifying, by the processing unit [104], at least one numeric alternate for the at least one numeric part of the each numeric query based on the negative indication, an intent of the at least one non-numeric part of said each numeric query and an availability of one or more similar products of the at least one product; and
providing, by the processing unit [104] at a display unit, an information related to the one or more similar products based on the at least one numeric alternate of the at least one numeric part and the availability of the one or more similar products.

2. The method as claimed in claim 1, wherein identifying, by the processing unit [104], at least one numeric alternate for the at least one numeric part is further based on a knowledge graph.

3. The method as claimed in claim 1, wherein the positive indication is generated based on a successful identification of the availability of the at least one product.

4. The method as claimed in claim 1, wherein the negative indication is generated based on an unsuccessful identification of the availability of the at least one product.

5. The method as claimed in claim 1, the method further comprises determining by the processing unit [104] the intent of the at least one non-numeric part of the each numeric query based at least on one or more non-numeric information present in the each numeric query and a pre-trained dataset.

6. The method as claimed in claim 1, wherein the availability of the one or more similar products is identified based at least on the intent of the at least one non-numeric part of the each numeric query.

7. The method as claimed in claim 1, wherein providing, by the processing unit at a display unit, an information related to the one or more similar products further comprises automatically replacing, by the processing unit [104], the at least one numeric part with the at least one numeric alternate of said at least one numeric part based at least on the negative indication and the availability of the one or more similar products.

8. The method as claimed in claim 1, wherein the at least one numeric part is at least one of at least one fixed numeric value and at least one numeric value range.

9. The method as claimed in claim 8, wherein the at least one numeric alternate of the at least one numeric part is a nearest possible numeric value of at least one of the at least one fixed numeric value and the at least one numeric value range.

10. A system for providing an information related to one or more similar products of at least one product, the system comprising:
a transceiver unit [102], configured to receive, at least one numeric query, wherein each numeric query comprises at least one numeric part and at least one non-numeric part;
a processing unit [104] configured to:
identify, an availability of at least one product corresponding to the at least one numeric query,
generate, one of a positive indication and a negative indication based on the identification of the availability of the at least one product,
identify, at least one numeric alternate for the at least one numeric part of the each numeric query based on the negative indication, an intent of the at least one non-numeric part of said each numeric query and an availability of one or more similar products of the at least one product, and
provide, at a display unit, an information related to the one or more similar products based on the at least one numeric alternate of the at least one numeric part and the availability of the one or more similar products.

11. The system as claimed in claim 10, wherein the processing unit [104] is configured to identify the at least one numeric alternate for the at least one numeric part based on a knowledge graph.

12. The system as claimed in claim 10, wherein the positive indication is generated based on a successful identification of the availability of the at least one product.

13. The system as claimed in claim 10, wherein the negative indication is generated based on an unsuccessful identification of the availability of the at least one product.

14. The system as claimed in claim 10, wherein the processing unit [104] is further configured to determine the intent of the at least one non-numeric part of the each numeric query based at least on one or more non-numeric information present in the each numeric query and a pre-trained dataset.

15. The system as claimed in claim 10, wherein the availability of the one or more similar products is identified based at least on the intent of the at least one non-numeric part of the each numeric query.

16. The system as claimed in claim 10, wherein the processing unit [104] to provide at the display unit, the information related to the one or more similar products is further configured to automatically replace the at least one numeric part with the at least one numeric alternate of said at least one numeric part based at least on the negative indication and the availability of the one or more similar products.

17. The system as claimed in claim 10, wherein the at least one numeric part is at least one of at least one fixed numeric value and at least one numeric value range.

18. The system as claimed in claim 17, wherein the at least one numeric alternate of the at least one numeric part is a nearest possible numeric value of at least one of the at least one fixed numeric value and the at least one numeric value range.
